(19) United States
(12) Patent Application Publication
(10) Pub. No.: US 2026/0201761 A1
(43) Pub. Date: Jul. 16, 2026

(54) SOLIDS TREATMENT USING FLUIDIZED BED PROCESS

(71) Applicant: Schlumberger Technology Corporation, Sugar Land, TX (US)

(72) Inventors: Reda KAROUM, Houston, TX (US); Steven Philip YOUNG, Houston, TX (US); Ben Lanning HOLTON, Florence, KY (US)

(21) Appl. No.: 19/127,745

(22) PCT Filed: Nov. 8, 2023
(86) PCT No.: PCT/US2023/079083

§ 371 Date: May 7, 2025

Related U.S. Application Data
(60) Provisional application No. 63/382,821, filed on Nov. 8, 2022.
(60) Provisional application No. 63/497,802, filed on Apr. 24, 2023.

(51) Int. Cl. E21B 21/06; F26B 3/08

(52) U.S. Cl. CPC E21B 21/065; F26B 3/08

(57) ABSTRACT

Methods and apparatus for treatment of hydrocarbon streams containing cuttings are described herein. The cuttings are treated in a treatment stage comprising a fluidized bed treater to reduce oil content of the cuttings to less than 1% by weight. The cuttings are provided to the treatment stage from a preparation stage that lowers oil content of the cuttings to a suitable range for the treatment stage and sizes the cuttings to a suitable dimension range for the treatment stage.

### CROSS-REFERENCE TO RELATED APPLICATIONS

This patent application claims benefit of U.S. Provisional Patent Application Ser. No. 63/382,821, filed Nov. 8, 2022, and of U.S. Provisional Patent Application Ser. No. 63/497,802, filed Apr. 24, 2023, each of which is entirely incorporated herein by reference.

### FIELD

This patent application describes apparatus and methods of treating solids produced during a drilling process in hydrocarbon prospecting. Specifically, the apparatus and methods described herein use fluidized bed processing to provide effective and environmentally conservative hydrocarbon removal from produced solids.

### BACKGROUND

Hydrocarbon is commonly sought by drilling a hole in the earth to establish a conduit from a subterranean hydrocarbon reservoir to the earth's surface. As the hole is drilled, fragments of rock, sand, water, and other materials are brought to the surface. When hydrocarbon is flowed to the surface using the well, the hydrocarbon often brings other materials, such as water, sand, pebbles, rock fragments, dust, and the like that are separated from the hydrocarbon at the surface. The solids are commonly referred to as “cuttings.” It is typically desired to return the cuttings to the environment without damaging the environment, but to do so hydrocarbon, potentially from the reservoir and/or from drilling fluids, must be removed from the cuttings. The cuttings are usually at least coated with hydrocarbon, which can be hydrocarbon from the reservoir, hydrocarbon from drilling fluids (i.e. oil base mud or synthetic base mud), or both, and may be penetrated to some extent by hydrocarbon, so a hydrocarbon removal process is used to remove the hydrocarbon. Conventional treatment processes are energy intensive, expensive, and only marginally effective, so improved processes for removing hydrocarbon from produced cuttings are needed.

### SUMMARY

Embodiments described herein provide a method of treating a hydrocarbon stream containing cuttings, the method comprising treating the cuttings in a treatment stage comprising a fluidized bed treater to reduce oil content of the cuttings to less than 1% by weight; and providing the cuttings to the treatment stage from a preparation stage that lowers oil content of the cuttings to a suitable range for the treatment stage and sizes the cuttings to a suitable dimension range for the treatment stage.

Other embodiments described herein provide a method, comprising reducing oil content of solids in a dryer; reducing a size of a portion of the solids in a sizer; and treating the solids in a fluidized bed treater in a treatment stage to reduce oil content of the solids to less than 1% by weight.

Other embodiments described herein provide a method, comprising reducing oil content of solids in a dryer; using a separator to separate solids from oil recovered in the dryer; reducing a size of a portion of the solids in a sizer; routing solids recovered in the separator to the sizer; and routing solids from the sizer to a fluidized bed treater in a treatment stage to reduce oil content of the solids obtained from the sizer to less than 1% by weight.

Other embodiments described herein provide a method, comprising reducing oil content of solids in a dryer to a target; using a separator to separate solids from oil recovered in the dryer; reducing a size of a portion of the solids in a sizer; routing solids recovered in the separator to the sizer; and routing solids from the sizer to a fluidized bed treater in a treatment stage to reduce oil content of the solids obtained from the sizer to less than 1% by weight, wherein the target is matched to a capacity of the fluidized bed treater.

### BRIEF DESCRIPTION OF THE DRAWINGS

FIG. 1 is a schematic process diagram of a solids treatment process according to one embodiment.

FIG. 2 is a schematic elevation view of a scalable fluidized bed treater according to one embodiment.

FIG. 3 is a schematic cross-sectional view of a solids treater according to one embodiment.

FIG. 4 is a process diagram of a solids treatment unit with heat integration.

FIG. 5 is a process diagram of a portion of a solids treatment unit that uses eductors to condense species from the vapor effluent of a solids treater.

### DETAILED DESCRIPTION

Efficient, environmentally conservative, and effective treatment of drill cuttings produced with a hydrocarbon stream uses a preparation stage, a treatment stage, and a finishing stage. The preparation stage accomplishes an initial drying and oil removal from the produced solids. The treatment stage uses a fluidized bed process to reduce the liquid content of the solids to a target level. The finishing stage recovers hydrocarbon, water, and fines that leave the treatment stage and optionally returns the hydrocarbon to the treatment stage. The methods and apparatus described herein is generally capable of reducing “oil on cuttings” (“OOC”) to less than 1% by weight, which is a common standard for release of cuttings to the environment in many areas.

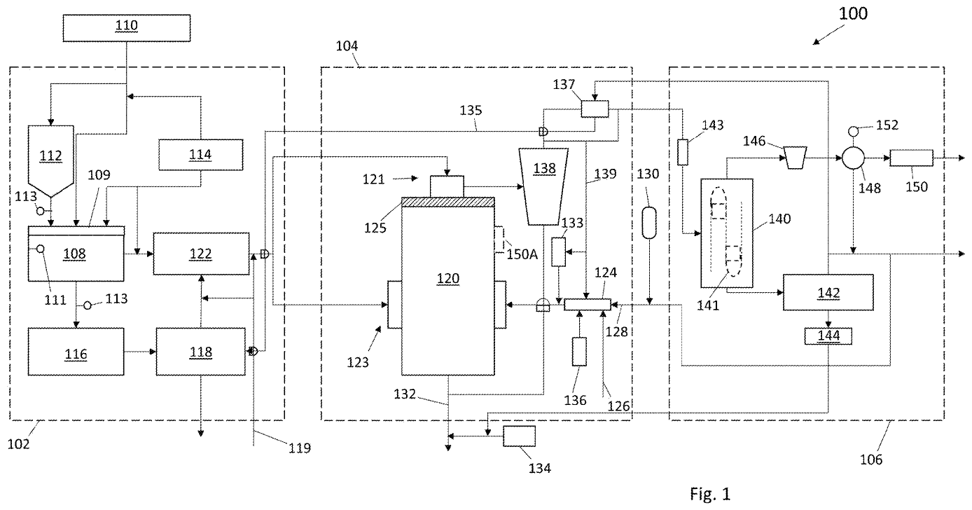

FIG. 1 is a process diagram of a process 100 for treating solids recovered during a drilling process. The process generally uses a preparation stage 102, a treatment stage 104, and a finishing stage 106. Solids produced from a well with hydrocarbon are separated from liquid using a crude separator, such as a shaking device, that yields solids wet with water and hydrocarbon. The solids may also include some gas trapped inside some solid particles.

The preparation stage 102 has an initial dryer 108. The solids from the crude separator are routed to the dryer 108, which uses motion, and optionally heat, to separate bulk liquid from solids. The motion can be solids motion, liquid motion, or gas motion, or any combination thereof. Solids are initially separated using an initial separator 110, which may be a shaker or other bulk separation unit. The solids can be routed to a storage unit 112 or directly to the dryer 108. The storage unit 112 is provided to manage solids throughput to the dryer 108, but bypassing the storage unit 112 can have the advantage of preventing excessing cooling of solids. Since the solids are to be thermally treated in downstream units of the process 100, avoiding excessive cooling in upstream units can be energy efficient. In offshore settings, the storage unit 112 may be one or more ISO-PUMP units, the ISO-PUMP being a slurry storage and handling unit available from SLB of Houston, Texas.

The solids are generally transported, in the process 100, using any conventional solids transportation mechanism, such as a blower, vibrating chute, single or double screw conveyor, or trough. One conventional solids transportation unit is the CCB CLEANCUT cuttings collection and transportation system available from SLB of Houston, Texas. The CCB CLEANCUT system is a pneumatic transport system frequently used in offshore settings due to its compact construction. Such a solids transportation system can be used, for example, to transport material from the separator 110 to the dryer 108, from the storage unit 112 to the dryer 108, and/or from the dryer 108 to other units described below. A transport aid source 114 can be used to add a transport aid to the solids to facilitate transportation. The transport aid can be a non-aqueous liquid similar to those used as base fluids in non-aqueous drilling fluids, such as mineral oil, paraffin and the like, which may be enhanced using an oil soluble surfactants or dispersants such as fatty acids, alkenyl succinic anhydrides, etc. The transport aid, which can be any suitable aqueous or non-aqueous fluid, can be added at the outlet of the initial separator 110, to lubricate solids flow, in a conduit or transportation mechanism that routes solids from the initial separator 110 to the storage unit 112, in a conduit or transportation mechanism that routes solids from the initial separator 110 to the dryer 108, or to the dryer 108 directly. A rotary valve 109 can be used at the top of the dryer 108 to control flow of solids into the dryer 108. The dryer 108 may be provided with a quantity sensor 111 to sense quantity of material in the dryer 108. The quantity sensor 111 may be a level sensor, a mass sensor, a volume sensor, or other quantity sensor. The quantity sensor 111 can be used to control operation of the rotary valve 109 so that material is charged to the dryer 108 at a rate that does not overfill or underfill the dryer 108.

It should be noted that, in some cases, an initial treatment other than, or in addition to, processing using a dryer could be used. In the process 100, the dryer 108 is used to reduce the OOC of cuttings to a level suitable for processing in the treatment stage 104. In some cases, a chemical treatment, either liquid or gas, could be used to reduce OOC. For a liquid chemical wash, a trommel or other liquid contacting apparatus could be used with, or instead of, the dryer 108. In particular, in some cases an initial treatment of cuttings to remove surface oil before more intensive treatments to remove embedded, absorbed, or strongly adsorbed oil can be useful. Processes based on washing, sonication, and/or cavitation can be used to remove such “surface” oils before the more intensive treatment based on toroidal bed processing is used, in some embodiments. Where an aqueous liquid chemical wash is used, the aqueous liquid can be separated from the solids using a suitable solids/liquid separation process prior to further processing of the solids.

Oil recovered from the solids in the dryer 108 can be collected in a tank 116. The recovered oil may have fine solids suspended therein, so the recovered oil can be routed to a solids separator 118, which may be a centrifuge, decanter, or other separation device, to reduce oil content of the fine solids. Some or all of the recovered oil can also be used to ensure the dryer 108 receives enough moisture for suitable operation. Thus, some or all of the oil recovered in the dryer 108 can be returned to the dryer feed, for example to the rotary valve 109 to moisten the feed to the dryer 108, if necessary. Moisture content of the dryer feed or effluent can be monitored using a moisture sensor 113, which can be coupled to the dryer feed and/or effluent (here shown coupled to both for illustration purposes). Re-use of separated oil in the feed to the dryer 108 can be controlled using such sensors.

The dryer 108 can be a cuttings dryer. The dryer 108 can be a centrifuge-type dryer, such as the Verti-GR unit available from SLB, of Houston, Texas, or a shaker-type dryer with drying enhancement, for example a screen pulse shaker like the Mongoose Pro® or Mongoose Max® shaker units also available from SLB. Where a screen pulse style shaker is used, oil removal is efficient, so throughput of solids to the treatment stage 104 can be higher. In such cases, if sizing is not needed, or if appropriately sized particles can be separated from those needing to be reduced in size, for example using an appropriately-sized screen in the screen pulse style shaker, at least some solids from the dryer 108 can be routed directly to the treatment stage 104. Generally, the dryer 108 is a unit that can produce solids that are fluidizable in a flow of gas and can be transported using pneumatic transportation.

The treatment stage 104 uses fluidized bed treatment to reduce oil content of the solids. The treatment stage 104 is most effective where the solids are sized such that gas movement can fluidize the solids. The size range depends on the parameters of treaters used in the treatment stage, chiefly gas flow rate, but in one case solids of dimension less than 3.5 mm, for example less than 2.5 mm, are suitable for treating in the treatment stage 104. Where the solids emerging from the dryer 108 are larger than 3.5 mm, the particle size is reduced by routing the solids to a sizer 122, which may be a grinder, crusher, or mill, to reduce the size of any large solid masses to an appropriate size. Solids recovered in the solids separator 118 can be routed to the sizer 122, or if the solids are already of appropriate size, can be combined to the effluent of the sizer 122. In some cases, the solids might not be fully separated from liquid, so solids from the solids separator 118 might emerge as a paste or other thick mixture of solids and liquid. Combining the solid-containing effluent of the solids separator 118 can enhance processing of solids in the sizer 122.

The separated oil is routed to other purposes, for example to a facility for preparing well drilling or well treatment fluids. Fine solids separated using the separator 118 are recombined with the main bulk of solids to be treated in the treatment stage 104. The fine solids can be added to the sizer 122 feed or effluent, or directly to the sizer 122 with the bulk solids. The fine solids separated in the separator 118 may be a paste, so adding the solids from the separator 118 to the sizer 122 input can provide some lubrication for operation of the sizer 122 and for transportation of solid particles. In some cases, other processes associated with hydrocarbon prospecting or production may produce solids or fines mixed with oil that needs separating or removal. For example, some hydrocarbon production facilities have solids control units that can produce a paste-like material comprising solid fines and oil. Such materials can be added to the process 100 at the sizer 122 or in the sizer effluent routed to the treatment stage 104, as illustrated by additional solids stream 119, where the material can be fluidized for transportation to the treatment stage 104, or otherwise routed to other uses or to disposal.

The treatment stage 104 uses a fluidized bed treater 120 to reduce OOC of the solids treated by the process 100 to a level less than 1% by weight. The fluidized bed treater 120 uses a flow of heated gas to fluidize solids into a distributed mass of particles that circulates around the interior of the treater 120 and is supported by the flow of heated gas. The pattern of moving gas and solids provides a more efficient and effective fluid removal from the solids than other dryer technologies.

The fluidized bed treater 120 may be a TORBED® processor available from Torftech Group of Thatcham, U.K. The TORBED processor is a fluidized bed treater that uses a toroidal flow pattern of gas and particles to promote efficient drying. At least one of the drying gas and the solids containing stream is injected into the toroidal processor in a tangential, or at least azimuthal, manner to create rotation of the contents of the treater. In some cases, both streams are injected in azimuthal or tangential direction. The solids are fluidized in a rotating flow pattern that promotes intimate contact between moist solids and drying gas to maximize removal of moisture from the solids. Moist gas moves upward in the treater and solids flow downward. Flow characteristics are adjusted to provide a suitable residence time for moisture removal. Solids spend a requisite amount of time contacting the drying gas, and upon settling downward have achieved a desired level of moisture, which may be zero.

Solids from the sizer 122 are routed to the treater 120. The solids can be provided to the treater 120 at a top 121 of the treater 120 or at a side 123 of the treater 120, or both. Where solids are provided to the top 121, a rotary valve can be used to charge solids to the interior of the treater 120 without releasing hot gases from the interior. In general, for all the solids treaters described herein, rotary valves can be used in this manner to provide the solids to the treaters for treatment.

Heated gas for the treater 120 is provided by a hot gas source 124, which may be a burner or furnace, and electrical heater, or other hot gas source. A gas stream 126 is provided to the hot gas source. In some cases, the gas stream 126 is an air stream, or another stream containing oxygen, for combustion. Fuel for the combustion is provided in a fuel stream 128 to the hot gas source. The fuel can be recovered from the finishing stage 106, or can be provided from a fuel source 130, which can be any combustible material, or both. Recovering oil and gas at the finishing stage 106 and using the recovered oil and gas for fuel to provide hot gas to the treater 120 improves energy efficiency and reduces environmental impact of the process 100. An environmentally conservative fuel source, such as biomethane, can also be used. Nitrogen from a nitrogen source 136 can be provided to the hot gas source to reduce hydrocarbon partial pressure in the vapor space of the treater 120 or to reduce flammability or explosive risk within the treater 120. It should be noted that the hot gas source 124 can also provide hot gas that is not heated using a combustion process. Any hot gas source can be used, and the gas can be pure nitrogen in some cases. For example, an electrical heater can be used to heat nitrogen gas, with no other gas source, for use in the treater 120. In many cases, the gas used for the treater 120 is mostly, or exclusively, nitrogen gas.

Solids sizing is performed here directly before solids are routed to the treater 120, but sizing can be performed elsewhere in the process 100, instead of or in addition to, using the sizer 122. For example, sizing of solids could be performed on solids being routed to the dryer 108, or to the tank 116, at the potential cost of separating some fine solids in the separator 118 and sending such fine solids to drilling fluids, which can disrupt the properties of drilling fluids.

Solids circulate in the treater 120 while hydrocarbon is eliminated from the solids. The clean solids exit the treater 120 in a clean solids stream 132. The treater 120 is typically operated at a temperature of 180° C. to 350° C., but in some embodiments can be higher, so the solids exit the treater 120 at high temperature. To ensure fines do not float if released to the ocean, the fines can be moistened using water from a water source 134, which can be sea water or another suitable water source. Gases provided to the treater 120, and gases separated from the solids in the treater 120, are recovered at an upper part of the treater 120 and are routed to a fines separator 138, which may be a cyclone or other gas/particle separation device. Here, the fines separator 138 is configured, with suitable materials and construction, to run at elevated temperatures due to the high temperature effluent of the treater 120. Fines separated in the fines separator 138 are collected and may be joined with the solids effluent of the treater 120. Although the fines separator 138 is shown here as a single unit, the fines separator 138 may comprise a plurality of operating units such as cyclones, filters, and the like, in multiple stages where needed.

Treatment of solids in the treater 120 can be enhanced by use of a source 125 of heating radiation. The source 125 may be any radiation source suitable for providing radiation capable of raising the temperature of the cuttings in the treater 120, or the fluids clinging to the cuttings. In one embodiment, the radiation source is a microwave radiation source configured, for example using suitable waveguides, to apply microwave radiation to the cuttings in the treater 120 as the heated gas circulates the cuttings. In another embodiment, the radiation source is an infrared radiation source, such as a heat lamp or heat lamp array, configured to apply infrared radiation to the cuttings in the treater 120 as the heated gas circulates the cuttings. The radiation source 125 is shown here located within the interior of the treater 120 at an upper portion thereof, in this case near the top 121, but the radiation source could be configured with the treater 120 in any suitable manner. For example, the radiation source could be located near the side 123 of the treater 120 closer to the circulation area of the cuttings, even surrounding the circulation area of the cuttings in some cases. The radiation source 125 could also be located in a lower portion of the treater 120 to apply radiation from below the circulation area of the cuttings. Combinations of radiation sources can also be used. A combination of microwave and infrared radiation sources can be used and radiation sources can be located in different parts of the treater 120, such as the top, bottom, and side thereof.

Here, the solids are routed directly from the sizer 122 to the treater 120, but in other versions, the solids could be routed from the sizer 122 to a storage unit that can send the solids to the treater 120. The storage unit could be included to manage any discrepancy in capacity of the preparation stage 102 and the treater 120. For example, where capacity of the treater 120 is substantially more or less than capacity of the preparation stage 102, solids from the preparation stage 102 can be routed to a storage unit, and inventory in the storage unit can be varied to optimize production rate of the treater 120 and/or the preparation stage 102. Where solids are routed to a storage unit before being treated in the treater 120, use of a transportation aid may be needed in the storage unit to flow the solids from the storage unit to the treater 120 smoothly. Re-moistening the solids after a particularly effective drying in the preparation stage 102 can be counterproductive overall in some cases and helpful in other cases.

Gases separated in the fines separator 138 and/or the fines scrubber 137 are routed to the finishing stage 106 to a condenser 140, where condensable gases are liquefied. The condenser 140 may include a cooler 141, shown here in phantom as an internal conduit for a cooling medium but which could be any convenient kind of cooler such as a cooling jacket around the condenser 140 or a heat exchanger at an inlet of the condenser 140. The cooling medium used in the condenser 140 can be water provided from the water source 134 (it should be noted that the water source 134 is not necessarily a single source, like a tank of water, but can generally be a local water source, like a tank of water, or a distributed water source such as ocean or other environmental water). A pressure unit 143 can be provided to adjust pressure of the gases provided to the finishing stage 106, either to increase or decrease the pressure thereof to a target pressure for condensation. Condensed liquids are routed to a liquid separator 142, where oil and water are separated if any water is present. Separated water is removed from a lower portion of the separator 142 and can be collected in a vessel 144 for any suitable purpose. The collected water can be used to supplement or replace water from the water source 134 for moistening fines and/or recovering thermal energy from hot solids exiting the treater 120, as further described below. Hydrocarbon separated as an oil in the separator 142 is recovered at an upper portion of the separator 142 and is routed to the fuel stream 128 for the hot gas source 124. Any excess oil recovered in the separator 142 that is not needed to operate the hot gas source 124 can be routed to any suitable purpose, for example to preparation of drilling fluids. Recovering the hydrocarbon in the finishing stage and using the hydrocarbon to heat the gas for the treatment stage 104 maximizes energy efficiency of the process 100 and reduces environmental impact of the process 100 by reducing the need to handle the separated oil.

As an alternative, rather than using the separator 142, the condenser 140 can be a staged condenser that separately condenses oil and water in separate stages. Thus, for example, a first stage of the condenser 140 can condense oil at a first thermodynamic condition, which can be collected at a lower portion of the first stage, and the gas remaining from the first stage can be routed to a second stage of the condenser 140 to condense water at a second thermodynamic condition. In this way, the separator 142 is avoided and footprint of the process 100 can be reduced where space is scarce, for example in an offshore facility.

Hydrocarbon from the separator 142 can also be used to remove any fine solids that may escape with gas from the fines separator 138. A fines scrubber 137 can be supplied with hydrocarbon from the separator 142, for example by misting or other method, to remove extremely fine solids that might be entrained with gas separated in the fines separator 138. Oil containing fines from the fines scrubber 137 can be returned in an oil recycle 135 to the solids separator 118, or to the feed or effluent thereof, to capture and reprocess the fines.

Gas separated in the fines separator 138 and/or the fines scrubber 137 can be returned to the treater 120, for example by combining a recycle gas 139 from the fines separator 138 effluent and/or the fines scrubber 137 effluent and routing the recycle gas 139 to the hot gas source 124. Re-use of hot gas from the treater 120 can reduce energy consumption associated with heating gas for the treater 120. Generally, where gas recycle is used, a portion of the gas will be recycled while a portion is forwarded to the finishing stage 106 to maintain moisture balance of the process 100. Gas recycle is generally useful where the hot gas used in the treater 120 is mostly or exclusively nitrogen, so that nitrogen can be reused in the process 100. It should be noted that, where the recycle gas 139 contains combustible material, such as hydrocarbon, the combustible material can be oxidized in the hot gas source 124 if conditions for oxidizing hydrocarbons are maintained in the hot gas source 124. For example, where the hot gas source is a burner or furnace, combustion of any hydrocarbons in the recycle gas 139, optionally by injecting the recycle gas 139 directly into a flame of the burner or furnace, can provide energy for achieving target temperature of the gas from the hot gas source 124, reducing external energy consumption of the process 100. In such cases, during startup of the process 100, the treater 120 will initially be operated entirely using external energy until hot gas effluents, potentially containing hydrocarbons, become available. As such recycle gases become available, external energy consumption can be reduced to a steady-state energy input according to the overall energy balance of the process 100. Alternately, or additionally, a converter 133, which can be a catalytic converter or thermochemical converter, can be used to convert hydrocarbons in the recycle gas 139. The thermochemical converter uses a controlled source of oxygen, such as air, to participate in the oxidation reaction with the hydrocarbons. A sensor of any known type can be used to send hydrocarbon content of the recycle gas 139 and to control oxygen injection to the thermochemical converter 133. Such conversion can raise the temperature of the recycle gas 139, which can then be routed to the hot gas source 124 or directly into the effluent of the hot gas source 124, as shown here.

Non-condensable gases from the condenser 140 are routed to a scrubber 146 to remove any trace liquid droplets from the gas. The non-condensable gases can include reservoir gases that were trapped in solid particles surfaced from the reservoir as well as products of thermal cracking where the fluidized bed treater 120 is operated at temperatures sufficient to cause thermal cracking. The gas from the scrubber 146 is routed to a splitter 148 configured to route all or part of the gas to join with the oil from the separator 142, if the gas is suitable for recycling, or to a remediator 150, which may be a catalytic convertor, carbon black bed (i.e., carbon filter), or other hydrocarbon conversion apparatus, before exhausting to the environment. A composition sensor 152 may be coupled to, or upstream of, the splitter 148 to determine whether the gas is suitable for recycle. The composition sensor 152 may be a gas chromatograph with flame ionization detector, or other suitable sensor. The splitter 148 may be a control valve that routes the gas to the fuel stream 128 or to the remediator 150, or splits the flow between the two units, or the splitter 148 may be a gas separator, such as a distillation unit, that can separate useful gases for recycle from non-useful gases for treatment by the remediator 150. Cryogenic distillation can be used for such a separation if refrigerant capacity is available. Other separations such as packed column or gel separation can also be used.

Where the remediator 150 is a catalytic converter, it is known that higher temperatures improve the performance of catalytic converters. Since the gas being treated at the remediator 150 has been substantially processed since leaving the treater 120, the gas may have cooled substantially. The remediator 150 is shown here, in phantom, in an alternate location 150A that can provide thermal energy to improve performance in the event the remediator 150 is a catalytic converter. The remediator 150 located at 150A is attached, or at least thermally coupled, to the outer wall of the treater 120. In such case, the alternate location exposes the remediator to high temperatures from the treater 120. In the event the gas feed to the remediator 150 has cooled, thermal energy from the treater 120 can penetrate the remediator 150 and heat the catalyst therein and/or the atmosphere therein to boost conversion.

In some cases, the fluidized bed treater 120 can be operated to oxidize oil and organics removed from solids in the treater 120. In the embodiments described above, the hot gas source 124 uses recovered oil to generate heat. In cases where the recovered oil is not used to generate hot gas in the hot gas source 124, organic material can be oxidized directly in the fluidized bed treater 120, and effluent from the treater can be routed to a thermal recovery use. In such cases, the condenser 140 and separator 142 might be omitted or the condenser 140 might be used just to condense water resulting from oxidation of the organics, with no recycle of oil to the hot gas source 124. Oxygen to oxidize the organics in the fluidized bed treater 120 can be provided directly to the treater 120, or excess oxygen can be provided to the hot gas source 124, which will use only fuel from the fuel source 130 to generate hot gas. The excess oxygen not consumed by combusting fuel in the hot gas source 124 can be flowed into the treater 120, and upon volatilizing organics, can react with the organics to generate carbon dioxide and water if there is enough excess oxygen. If the excess oxygen from the hot gas source 124 is less than an amount needed to completely oxidize organics in the treater 120, the treater 120 may partially oxidize the organics to form a syngas-type effluent comprising carbon monoxide, carbon dioxide, hydrogen, and water, potentially with some unreacted organics. Such an effluent can be refined for production of useful chemicals according to known processes. For such oxidation processes, the treater 120 runs at elevated temperatures of about 600° C. or above. Where solids charged to the treater 120 contain carbonates, operating temperature of the treater 120 may be kept below about 500° C. to avoid generating CO₂ by thermal decomposition of the carbonates. Thus, in addition to a drying mode, where useful oil is potentially recovered, the fluidized bed treater 120 can be operated in a combustion mode, an oxidation mode, a partial combustion mode, or a partial oxidation mode.

The fluidized bed treater 120 is designed to reduce the OOC of solids to a level less than 1%, and to use the recovered oil as an energy source for the fluidized bed treater. The solids may have OOC of 15% or more, such as from 3% to 15%. No reasonable upper limit is known to the OOC content of solids that can be successfully treated using toroidal bed processing to reduce the OOC of solids to less than 1%, although higher OOC solids may take longer to process. The OOC of solids that can be effectively processed in a fluidized bed treater is limited only by the need to fluidize the particles in the treater. If fluid content of the particles is too high, the particles can agglomerate and reduce effectiveness of the operating mode of the treater. The preparation stage 102 is operated to provide solids that can be effectively processed using the treater 120. Capacity of the treater 120 is influenced by heat input capability of the hot gas source 124 (i.e., thermal capacity in kilowatts) and gas flow capacity from the hot gas source (and another gas source if any supplemental gas is used to target an overall gas flow volume). Capacity of the treater 120 is also influenced by moisture content, that is oil, water, or other liquids, of the solids charged to the treater 120. Operating at capacity, the treater 120 will be able to process more solids at lower OOC or fewer solids at higher OOC up to the maximum stated above.

Flow rate of solids to the treater 120 can be adjusted based on flow rate of solids exiting the sizer 122 and based on OOC of solids exiting the sizer 122. Additionally, the preparation stage 102 can be operated to target an OOC of solids exiting the sizer 122 that is based on flow rate of solids entering the preparation stage 102 from the separator 110 or solids exiting the sizer 122, or any parameter generally representing production rate of the preparation stage 102, so that throughput of the preparation stage 102 can be matched to capacity of the treater 120. In one case, a fluid flow rate exiting the sizer 122 with solids from the sizer 122, or entering the preparation stage 102 from the separator 110, can be computed and controlled as a parameter of preparation stage operation and/or treater input. Fluid flow rate at any point can be monitored by measuring flow rate of solids using known methods and by sampling the solids to analyze OOC of the solids. The product of solids flow rate and fluid content of the solids is fluid flow rate. If the fluid flow rate exiting the sizer 122, or if the fluid flow rate entering the preparation stage 102 from the separator 110, is higher than the treater 120 can process, treatment of solids in the preparation stage 102 can be intensified to remove more fluid in the dryer 108, and vice versa. Capacity, and turndown capability, of the solids separator 118 can be selected based on variability expected in operation of the dryer 108, and multiple separators 118 can be provided if selectable scalability is needed during operation. Capacity of the treater 120 can also be varied by increasing or decreasing operating temperature of the treater 120.

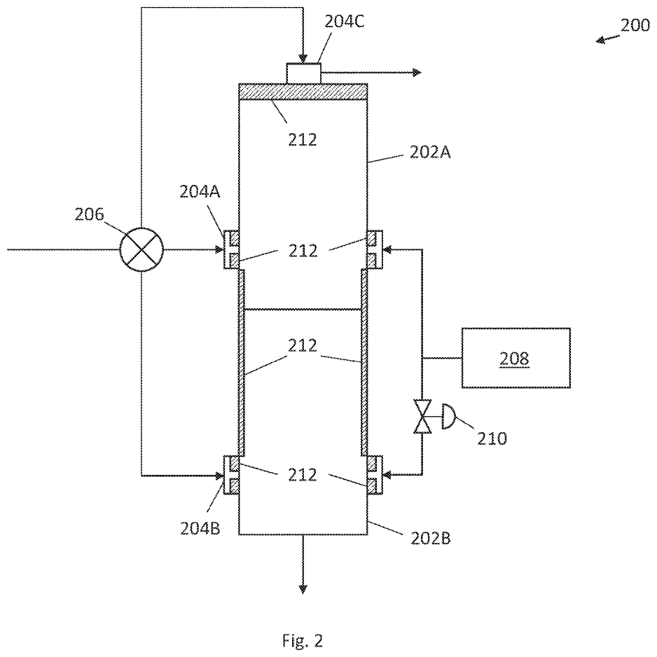

Selectable scalability can also be provided in a fluidized bed treater. FIG. 2 is a schematic elevation view of a scalable fluidized bed treater 200. The scalable fluidized bed treater 200 can be used as the treater 120 of the process 100 in the event scalable treatment is needed. The treater 200 has two stages 202A and 202B, which are stacked vertically to interoperate. An upper stage 202A is designed to fluidize solids in a hot gas, with treated solids falling into a lower stage 202B. If additional treatment with hot gas is needed before the solids can be discharged from the treater 200, the solids can be fluidized by the hot gas in the lower stage 202B to complete fluid removal.

As with the treater 120, fluid-containing solids can be provided at side-entry or top-entry locations, or all of the above. Each of the lower and upper stages 202B and 202A has a side entry 204, an upper side entry 204A being associated with the upper stage 202A and a lower side entry 204B being associated with the lower stage 202B. The treater 200 also has a top entry 204C. A flow control device 206 can divert solids between the entry points of the treater 200 based on desired loading of the two stages 202A and 202B or other criteria.

Hot gas is generally provided from a hot gas source 208 to the upper stage 202A by default. A flow control device 210 can be used to control flow of hot gas from the hot gas source 208 to the lower stage 202B based on an amount of incremental processing needed in the lower stage 202B. Where dual processing in the treater 200 is desired, hot gas can be provided to both stages 202A and 202B. Solids falling out of the upper stage 202A will encounter hot gas provided to the lower stage 202B, which will fluidize the solids at the lower stage 202B for further fluid removal. Flows of solids and hot gas to the upper and lower stages 202A and 202B can be incrementally adjusted to provide more or less processing in the lower stage 202B. For example, an amount of hot gas can be provided to the lower stage 202B that is less than the amount of hot gas provided to the upper stage 202A if scalability to a processing rate that is less than 100% capacity is desired. In this way, a processing rate that is greater than the processing rate of a single bed treater, like the treater 120, can be selected by routing hot gas to the lower stage 202B. The treater 200 can be useful where horizontal space for a large single-stage fluidized bed treater, such as the treater 120, is limited. More than two stages can be used if desired without technical limitation. Any or all stages of the treater 200 can be toroidal processors.

The treater 200 can also have radiant heating, as described for the treater 120. Here, radiant heaters 212 are provided at the location of each fluidized bed, in the upper stage 202A and in the lower stage 202B. Radiant heaters 212 are also shown at the top of the treater 200 and along the inner wall of the treater 200 between the locations of the two fluidized beds, along a lower portion of the upper stage 202A and along an upper portion of the lower stage 202B. The radiant heaters 212 can also provide incremental scalable treatment capacity that can be selected. For example, all, or any subset, of the radiant heaters 212 (providing heating radiation that can be microwave, infrared, or any combination thereof) can be energized to provide radiant heating throughout the treater 200 or at selected locations thereof.

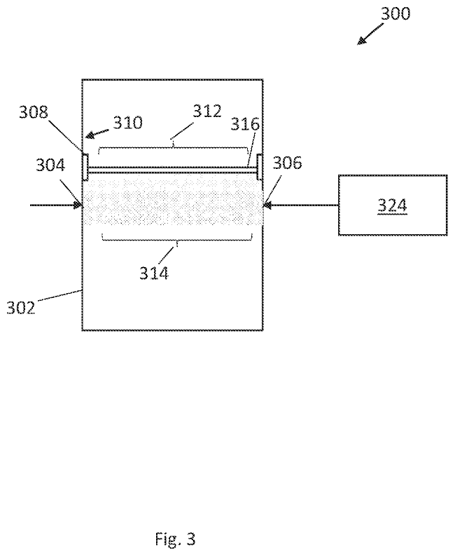

Oil vaporized from contaminated cuttings in a treater can be partially or fully oxidized or pyrolyzed to provide energy for the vaporization process. As noted above, a fluidized bed treater can be operated at temperatures of 600° C. or above (or no more than about 500° C. where the solids contain carbonates, as described above) to oxidize, partially or completely, organic molecules in the vapor space of the treater. Partial or complete oxidation, and/or pyrolysis, of organics in a treater can be accomplished at lower temperatures, such as between about 180° C. and 250° C., using a catalyst. A catalyst can be included in the treater to catalyze partial or complete exothermic reactions of organic molecules, yielding thermal energy from the exothermic reaction. FIG. 3 is a schematic cross-sectional view of a treater 300, according to one embodiment. The treater 300 has a vessel 302 in which solids are treated in a fluidized bed process, which may be a toroidal process. Solids having organic molecules are provided to the vessel at a first inlet 304 and hot gas is provided at a second inlet 306.

The treater 300 has a catalytic layer 308 disposed at an interior wall 310 of the vessel 302. The catalytic layer 308 is made of a material, such as platinum, iron, vanadium, molybdenum, and/or other catalysts to fully or partially oxidize and/or pyrolyze organic molecules, such as hydrocarbons, surfactants, demulsifiers, and the like, that are vaporized from the solids. Mixtures of such materials can also be used. Electrooxidation catalysts can also be employed for the catalytic layer 308. Electric current can be provided to the catalytic layer 308 utilizing electrooxidation catalysts to facilitate oxidation of organic molecules at the surface of the catalytic layer 308. Where chemical catalysts are used that do not use electric current to enhance reactions, no electric current is needed. The catalysts generally use thermal and/or electric energy to activate reactions between organic molecules and oxygen molecules, or decomposition reactions, in the vapor space of the treater 300, providing thermal energy from the reactions. As a result, the hot gas can be provided to the treater 300 at a lower temperature of 150° C. to 250° C. In such cases, conversion of organics can be controlled by use of catalytic materials, and general thermal degradation of organics can otherwise be minimized.

The catalytic layer 308 may be a thin film of metal, or other catalytic material, deposited on the inner wall 310 of the vessel 302. The catalytic layer 308 is located at a catalytic zone 312 of the vessel 302 generally a small distance above a fluidized bed zone 314 of the vessel 302. Organic molecules vaporized from the solids flow upward with gas in the treater 300, with concentration of such organic molecules in the gas being maximum at a location near the top of the fluidized bed zone 314, where all solids that possibly can contribute have contributed molecules to the vapor phase. Locating the catalytic layer 308 at a catalytic zone 312 near or just above the fluidized bed zone 314 accesses the maximum concentration of organic molecules in the vapor phase to extract energy from the vapor most efficiently while still allowing some contact between the released energy and solids still burdened with organic molecules. Locating the catalytic layer 308 at a catalytic zone 312 near or just above the fluidized bed zone 314 also reduces scouring of the catalytic layer 308 by circulating solids in the fluidized bed. While some solids may contact the catalytic layer 308, reducing such contact generally prolongs effectiveness of the catalytic layer 308. The catalytic layer 308 can be located at other locations or elevations within the vessel 302, which may be optimal locations for other embodiments. The relationship of the optimal location of the catalytic layer 308 and the fluidized bed zone 314 depends on the mode of operation of the treater 300. If the treater 300 is operated with a thin fluidized bed zone 314, the catalytic layer 308 may be optimally located closer to the first and second inlets 304 and 306. A protective screen (not shown) may be used to cover the catalytic layer 308 to reduce the impact of circulating solids on the catalytic material of the catalytic layer 308. In such cases, it may be advantageous to extend the catalytic layer 308 closer to the first inlet 304, or even beyond the first inlet 304 such that the first inlet 304 is formed through the catalytic layer 308.

The catalytic layer 308 can be formed by any convenient layer-forming method, such as sputtering, plating (electrochemical plating or electroless plating), thermal deposition, or other deposition methods. The treater 300 may be operated using an oxygen-containing atmosphere to facilitate partial or full oxidation of organic molecules in the vapor space thereof. Alternately, the treater 300 may be operated using a non-reactive gas to provide an oxygen-free atmosphere, so the treater 300 has no output of carbon oxides. As described above, oxygen may be used in the hot gas source 124 to combust a fuel. Excess oxygen can be provided to the hot gas source 124, such that unused oxygen flows into the vessel 302 to participate in the catalytic oxidation process. Alternately, oxygen can be provided directly to the vessel 302. Alternately, the hot gas source 124 can be operated in oxygen deficiency to ensure no oxygen flows to the treater 300. Where no oxygen is provided to the treater 300, and where conditions otherwise provide, pyrolysis reactions will predominate.

Where solids inside the vessel 302 might reduce effectiveness of the catalytic layer 308, either by fouling or abrasion, a shield or filter (not shown) can be provided to prevent or reduce solids contact with the catalytic layer 308. The shield or filter can be positioned proximate to the surface of the catalytic layer 308 to allow gases to flow to the catalytic layer 308, prevent or reduce contact of solids with the catalytic layer 308, and minimize impact on flow through the vessel 302.

The treater 300 can be used in the process 100 of FIG. 1 in place of the treater 120. Depending on conversion of organic molecules by operation of the catalytic layer 308, much of the liquids handling equipment of the process 100 may be avoidable. For example, if nearly all organics are converted in the treater 300, the separator 142 can likely be omitted, although treatment of residual organics might still be needed before water condensed from the effluent gas of the treater 300 can be released to the environment. If the condenser 140 is operated to avoid condensing organics such that no trace organics are in the condensed water, then such treatment can be avoided. Residual organics in vapor released from the treater 300 can be oxidized in the remediator 150, and in general remediation of organics in the vapor effluent of the treater 300 can be diminished.

An optional added surface area structure 316 can be used in the treater 300 to increase contact between vapors in the treater 300 and a catalyst for obtaining thermal energy from the vapors. The added surface area structure 316 can take any convenient form, and is shown here as a structure that extends across the internal volume of the vessel 302 at a location within the catalytic zone 312 to facilitate increased reaction within the catalytic zone 312. The added surface area structure 316 can be made of, or coated with or painted with, catalytic material, and can take the form of a rod, a collection of rods, a tray with holes to allow vapor to flow through the tray, a mesh, a grid, a screen, a honeycomb or chicken wire grid, a cluster or “cloud” of catalytic fibers, a baffle or collection of baffles to create a tortuous flow path for vapors ascending within the vessel 302, or any convenient form articulated in any way to any extent horizontally, vertically, or otherwise within the vessel 300. Structures used for the added surface area structure 316 are generally selected to provide a wanted degree of contact surface without substantially burdening gas flow in the vapor space of the treater 300. The type or configuration of added surface area structure will thus depend on characteristics of specific processes.

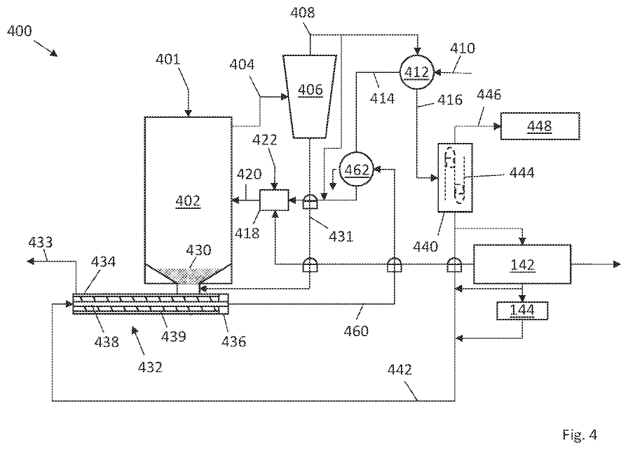

Heat can be recovered from the treaters 120, 200, and 300 to improve energy efficiency. FIG. 4 is a process diagram of a solids treatment unit 400 with heat integration. The solids treatment unit 400 can be used as any of the treaters 120, 200, or 300. A treatment vessel 402, operating in any manner described herein to remove organic molecules from solids, removes organic molecules from a solids stream 401 to yield a vapor effluent 404. The vapor effluent 404 may exit the vessel 402 at temperatures of 150° C. or higher, and in cases where all organics are oxidized the effluent 404 may have temperature of 600° C. or higher. Where the solids contain carbonates, operating temperature of the vessel 402 may be kept below 600° C. to avoid converting the carbonates to CO₂. In general, to minimize energy used to treat solids in the solids treatment unit 400, and potentially to minimize thermal degradation of organic molecules in the solids treatment unit 400, operation temperature of the vessel 402 can be as low as 150° C. In such cases, organic molecules can be recovered for suitable use.

As in the process 100, the vapor effluent 404 is routed to a fines separator 406, which may be the fines separator 138, and which may comprise multiple operating units such as cyclones, filters, and the like. A fines-free vapor effluent 408 is obtained from the fines separator 138 at a high temperature. The thermal energy of the fines-free vapor effluent 408 can be recovered to the process of the solids treatment unit 400 in a number of ways that can be used singly, or in any combination.

The fines-free vapor effluent 408, or a portion thereof, can be routed to a hot gas source 418 that provides hot gas to remove organic molecules from solids in the vessel 402 by evaporation. Where the hot gas source is a burner or furnace, fines-free vapor effluent 408 can be injected directly into a flame to combust any hydrocarbon remaining in the fines-free vapor effluent 408. Where the hot gas source is an electric heater, a thermochemical converter can be used, as described in connection with FIG. 1, to oxidize any residual hydrocarbon and provide incremental heating to the fines-free vapor effluent 408. Alternately, or additionally, the fines-free vapor effluent 408, or a portion thereof, can be thermally contacted with a gas stream 410 in a thermal contactor 412 to form a heated gas stream 414. The fines-free vapor effluent 408 is cooled by the thermal contact to form a cooled effluent 416. Here, the heated gas stream 414 is routed to an optional second thermal contactor 462, described further below, and then to a hot gas source 418, which provides a hot gas stream 420 to the vessel 402 to volatilize organics from a solids stream. Incremental heating can be applied to the heated gas stream 414 to yield the hot gas stream 420 by utilizing an energy source 422, shown here as an input stream, which can be, for example, a fuel source for combustion. The energy source 422 can be other forms of energy, such as electrical energy or steam, to provide heat to the heated gas stream 414. Recovering heat from the vapor effluent 404 minimizes the additional energy that must be added using the energy source 422, improving energy efficiency of the solids treatment unit 400.

The cooled effluent 416 is routed to a collector 440, which may also be a condenser like the condenser 140 of the process 100. Where the thermal contactor 412 extracts enough heat energy from the fines-free vapor effluent 408 to condense the condensable portions thereof, the collector 440 merely collects the condensed liquid 442, which in this case is mostly or completely water. Incremental cooling can be provided to the collector 440 by an internal cooler 444, which can be like the cooler 141, to ensure all condensables are liquefied. The condensables may be water, mostly water with a trace of organic molecules, or a mixture of water and organic molecules. Optionally, the liquid separator 142 can be used to separate water from organic molecules, and the water can optionally be collected in the vessel 144. The collected water can be used to recover thermal energy from the vessel 402, as further described below. As in the process 100, organic molecules recovered in the liquid separator 142 can be routed to the hot gas source 418 to provide thermal energy and/or recovered for other use, such as for blending into drilling fluids.

Vapor 446 from the collector 440, which may contain carbon oxides (CO and CO₂ in proportions depending on operation of the treater 400), but may contain volatile organic molecules that were not reacted in the treater 400 or were pyrolized in the treater 400 to smaller organic molecules, and were not condensed in the collector or the thermal contactor 412, can be finished in a finishing unit 448, which can include a liquid scrubber like the scrubber 146 of the process 100, a splitter 148, and a remediator 150, to remove residual organic molecules.

It should be noted that where the fines-free vapor effluent 408 is totally recycled to the hot gas source, water vapor will be recycled into the vessel 402 and will build up in the process. To remove the water vapor generated by reaction of organic molecules with oxygen in the vessel 402, if any, a portion of the fines-free vapor effluent 408 can be routed to the thermal contactor 412. The thermal contactor 412 can be sized to transfer enough thermal energy from the fines-free vapor effluent 408 to condense most or all of the condensable species, water vapor and potentially some organic molecules, contained in the fines-free vapor effluent 408 to be collected in the collector 440 for further use in heat recovery as described elsewhere herein. It should also be noted that water balance of the solids treatment unit 400 can be maintained by routing a portion of the fluid obtained by cooling the hot fluid 460 back to the collector 440. The portion to be recycled can be controlled by reference to a liquid level in the collector 440, as is commonly practiced in process industries.

Hot solids 430 exit the vessel 402 from the bottom of the vessel 402 or from a lower portion of the vessel 402. The hot solids 430 are routed into a solids mover 432 equipped with thermal recovery. Fines 431 recovered in the fines separator 406 can be combined with the hot solids 430 into the solids mover 432. In this case, the solids mover 432 is a screw conveyor that uses a rotating screw 434 to move solids from the outlet of the vessel 402 to a disposition, which can be any convenient use or return to the environment. The screw 434 is rotated using a motor 436. A fluid conduit 438 is disposed through the shaft of the screw 434, and optionally through the motor 436, to circulate a fluid and to recover heat from the solids being transported by the solids mover 432. The fluid conduit 438 may also include a hollow portion of the flights of the screw 434, such that the entire screw 434, shaft and flights, is hollow and can serve as a conduit for cooling fluid. The screw 434 can also be surrounded by a plenum 439 to circulate the fluid for more thermal contact. In some cases, the conduit 438 and the plenum 439 can define a single fluid pathway to circulate fluid through and around the screw 434. Flow controls, such as baffles or vanes, can be provided within the plenum 439 to increase the length of the fluid pathway within the plenum 439 for more thermal contacting time. The shaft of the screw 434 can also have a tapered diameter to decreasing flow velocity and increasing residence time for portions of the screw 434 where such features can benefit heat recovery. The fluid can be the condensed liquid 442 obtained from the collector 440, water from the liquid separator 142 or from the vessel 144, or a combination thereof, and can be routed through the conduit 438 in a counter-current manner to maximize heat recovery from the hot solids 430. The solids are cooled in the solids mover 432 to a suitable temperature for return to the environment as a solids return stream 433, or other handling, and a hot fluid 460 is obtained from the conduit 438.

To recover the heat transferred to the hot fluid 460 into the process of the solids treatment unit 400, the hot fluid 460 is routed to an optional second thermal contactor 462, in which case the thermal contactor 412 would be a first thermal contactor 412, for thermal contact with the heated gas stream 414. The hot fluid 460 further increases the temperature of the heated gas stream 414 to minimize additional heating needed in the hot gas source 418. It should be noted that, where thermal conditions of various materials warrant, the hot fluid 460 can be routed directly to the thermal contactor 412 so that only one thermal contactor is needed to exchange thermal energy among the fines-free vapor effluent 408, the hot fluid 460, and the gas stream 410 to be used as a hot gas for removing organic molecules from solids in the vessel 402. The hot fluid 460 is cooled, and may be returned to the environment after suitable conditioning or routed to other processing. The solids treatment unit 400 thus provides integration of thermal energy, CO₂, and water recovered from reaction of organic molecules with oxygen, if any.

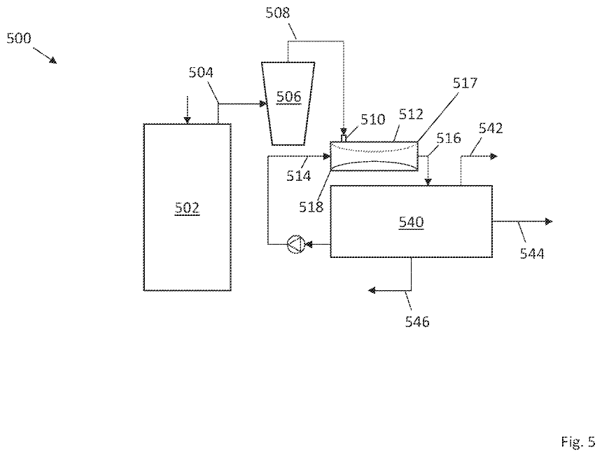

A particularly efficient way of condensing condensable species in effluent from the treaters described herein can be obtained using eductors to remove condensables from the vapor. FIG. 5 is a process diagram of a portion of a solids treatment unit 500 that uses eductors to condense species from the vapor effluent of a solids treater. A vessel 502 is used to evaporate organic molecules and, optionally, oxidize or pyrolyze such molecules, as described herein. Vapor effluent 504 of the vessel 502 is routed to a fines separator 506, similar to the other processes herein. Fines-free vapor effluent 508 is routed to an inlet port 510 of an eductor 512 to remove condensable species from the fines-free vapor effluent 508 into an education medium 514. A two-phase fluid 516 exits the eductor 512 via an exit throat 517 and is routed to a collector 540, which may be like the collectors 140 and 440 of the processes 100 and 400. Gas 542, oil 544, and water 546 can be routed to other uses as described herein. The education medium 514 is removed from the collector 540 at a suitable location to obtain a desired material (i.e. water or oil) and pumped into an inlet throat 518 of the eductor 512. The inlet port 510 is located near the inlet throat 518 of the eductor 512 so that flow of the education medium 514 reduces pressure at the inlet port 510 to encourage condensation of condensable species from the fines-free vapor effluent 508 into the circulating education medium 514. Flow rate of the education medium 514 can be adjusted, within an operating window, to increase or decrease condensation, even to maximize condensation where desired.

While the foregoing is directed to embodiments of the present invention, other and further embodiments of the present disclosure may be devised without departing from the basic scope thereof, and the scope thereof is determined by the claims that follow.

We claim:

1. A method, comprising:
reducing oil content of solids in a dryer;
reducing a size of a portion of the solids in a sizer; and
treating the solids in a fluidized bed treater in a treatment stage to reduce oil content of the solids to less than 1% by weight.

2. A method, comprising:
reducing oil content of solids in a dryer;
using a separator to separate solids from oil recovered in the dryer;
reducing a size of a portion of the solids in a sizer;
routing solids recovered in the separator to the sizer; and
routing solids from the sizer to a fluidized bed treater in a treatment stage to reduce oil content of the solids obtained from the sizer to less than 1% by weight.

3. A method, comprising:
reducing oil content of solids in a dryer to a target;
using a separator to separate solids from oil recovered in the dryer;
reducing a size of a portion of the solids in a sizer;
routing solids recovered in the separator to the sizer; and
routing solids from the sizer to a fluidized bed treater in a treatment stage to reduce oil content of the solids obtained from the sizer to less than 1% by weight, wherein the target is matched to a capacity of the fluidized bed treater.

4. The method of any of claims 1 to 3, wherein reducing the size of the portion of the solids comprises reducing a maximum dimension of the solids to 3.5 mm.

5. The method of claims 1 to 4, further comprising collecting hydrocarbon separated from the solids and using the hydrocarbon to provide hot gas to the fluidized bed treater.

6. The method of any of claims 1 to 5, further comprising applying heating radiation to the solids in the fluidized bed treater.

7. The method of any of claims 1 to 6, further comprising recycling hot gas of the treatment stage.

8. The method of claim 7, wherein recycling hot gas of the treatment stage comprises converting hydrocarbons in the recycled gas.

9. The method of claim 8, wherein treating the solids in the fluidized bed treater comprises heating a treatment gas using a hot gas source, and converting hydrocarbons in the recycled gas comprises combusting the hydrocarbons in the hot gas source.

10. The method of claim 9, wherein treating the solids in the fluidized bed treater comprises heating a treatment gas using a hot gas source, and converting hydrocarbons in the recycled gas comprises oxidizing the hydrocarbons in a converter.

11. The method of any of claims 1 to 10, further comprising providing a catalytic layer within the fluidized bed treater and obtaining thermal energy by converting organic molecules using the catalytic layer.

12. The method of any of claim 1 to 8 or 11, wherein treating the solids in the fluidized bed treater comprises heating a treatment gas in an electrical heater.

13. The method of any of claims 1 to 12, further comprising recovering fines from an effluent of the fluidized bed treater and combining the recovered fines with solids exiting the fluidized bed treater.

14. The method of any of claims 1 to 13, further comprising recovering heat from the solids exiting the fluidized bed treater.

15. The method of any of claims 1 to 14, further comprising condensing condensable materials in gas from the fluidized bed treater.
